(19) United States
(12) Patent Application Publication
(10) Pub. No.: US 2019/0154010 A1
(43) Pub. Date: May 23, 2019

(54) METHOD AND APPARATUS FOR POWER PRODUCTION

(71) Applicant: EAVOR TECHNOLOGIES INC., Calgary (CA)

(72) Inventor: MATTHEW TOEWS, CALGARY (CA)

(21) Appl. No.: 16/181,492

(22) Filed: Nov. 6, 2018

Related U.S. Application Data
(60) Provisional application No. 62/588,328, filed on Nov. 18, 2017.

(51) Int. Cl. F03G 7/04; F01K 7/16; F01K 3/18; F01K 25/08; C09K 5/04

(52) U.S. Cl. CPC F03G 7/04; F01K 7/16; C09K 5/048; F01K 25/08; F01K 3/18

(57) ABSTRACT

Methods and fluids for generating power with closed well loops in a geothermal environment. The loops may be segregated or non segregated. Operation of the loop circuits is dynamically modifiable in subzero temperatures which contributes to higher and efficient power output. Specific working fluid compositions, including drag reducers, complement the efficiency together with the absence of casing within the loop for maximum thermal transfer between the formation and the working fluid.

### FIELD OF THE INVENTION

The present invention relates to a method and apparatus for producing energy and more particularly, the present invention contains enhancements in segregated and integrated well loop circuits for generating geothermal power.

### BACKGROUND OF THE INVENTION

A wide variety of methods have been proposed regarding heat extraction from geological formations and the prior art is quite extensive in this area.

Halff, in U.S. Pat. No. 6,301,894, issued Oct. 16, 2001 teaches a general flash geothermal plant within a closed system. The patent is focused on benefits related to generator location, water conservation and purity and efficiency with multiple loops. The teachings relate to a flash power plant on surface with water/steam as a working fluid. This technology is limited since it requires much higher temperatures and does not work in a low temperature, closed loop setting.

There are several methods for generating power from a closed-loop geothermal system, namely with an integrated power cycle or with a separate segregated (binary) power cycle such as Organic Rankine Cycle, Kalina Cycle, Supercritical Carbon Dioxide Cycle, or Carbon Carrier Cycle.

In respect of the segregated system, this has been applied in traditional open geothermal systems, where the cooling temperature of the segregated cycle is limited by the reservoir brine properties. The segregated method in conjunction with a closed-loop system is briefly taught in the prior art, examples of which are United States Patent Publication, 20110048005, McHargue, published Mar. 3, 2001 and Mickelson, in United States Patent Publication 20070245729, published Oct. 25, 2007, with no discussion on how to increase net efficiency.

McHargue also teaches an integrated closed loop system with variation in the production fluid choice to address temperature fluctuation within the formation. The text states:

“A novel aspect of this embodiment is the opportunity it affords to use a wide variety of potential fluids as the production fluid as well as the ability to rapidly and easily change production fluids as subterranean temperatures change or as conditions in the power plant change. The user has the option to use fluids or gasses other than water as production fluids in order to optimize the thermal properties of the production fluid to the local thermal conditions of the earth's subsurface, and the thermal requirements of the power plant. For example, one may choose to utilize supercritical fluids (U. S. Pat. No. 6,668,554 by D. W. Brown, 2003) or any hydrocarbon or refrigerant as the production fluid to feed a power plant. The potential to use fluids or gasses other than water as the production fluid will save money by providing the potential to drill cooler subterranean rocks at shallower depths where porosity and permeability are higher, and by reducing the need to artificially fracture the subterranean rock formations.”

There is no discussion of multilateral wellbores sealed without the use of casing. Additionally, no discussion is provided on the selection of working fluid properties to increase efficiency.

Mickelson teaches a multiple leg geothermal recovery system. The publication expresses a concern about geo-fluid loss and thus temperature loss and does not provide any teachings to seal the wellbores without casing or to mitigate the east-west problems associated with directional drilling, i.e. magnetic interference, inter alia.

Riahi et al, in a paper entitled, Innovative Closed-Loop Geothermal Well Designs Using Water and Super Critical Carbon Dioxide as Working Fluids, from PROCEEDINGS, 42nd Workshop on Geothermal Reservoir Engineering,Stanford University, Stanford, Calif., Feb. 13-15, 2017, disclose sensitivity studies regarding injection temperature and flow rate for GSL design with water as the working fluid. The results of this segregated configuration were compared to results for the ECO2 integrated system technology under identical conditions (Oldenburg et al., 2016). The authors discovered that the systems had similar efficiencies in a basic form. The paper did not examine methods to increase efficiency of a segregated closed-loop geothermal system.

There has been a wide body of academic work around using carbon dioxide in an “enhanced geothermal system” within basement rock (below the sedimentary column). In this concept, the hot dry rock is fractured and carbon dioxide flows through the fissures within the rock itself. Several pilot projects using water (not carbon dioxide) have been implemented and suffered from unpredictability of the fracture matrix and high costs. Further, since these are not truly closed-loop systems, there is a requirement for continuous replenishment of carbon dioxide which is prohibitively expensive.

In light of the prior art activity, there still remains areas in closed loop geothermal technology which can be improved on. As referenced generally above, many of the issues can be solved by using multilateral wellbores sealed without casing, enhancements to a segregated power cycle, and an integrated power cycle with a working fluid containing a mixture of polar and non-polar molecules which undergo a phase-change in the lateral portion of the well-loop.

The present invention unifies thermodynamic principles, power generation and well loop technology with fluid heat exchange in a unique manner to maximize power generation in a variety of conditions. Specifically, loop properties and features are optimized for maximum efficiency. Applicability is this is noted in segregated and non segregated systems. Improvements are further provided in multilateral systems with sealing of the loop without casing and working fluids are provided which complement the other improvements.

### SUMMARY OF THE INVENTION

One object of one embodiment of the present invention is to provide unique protocol to render closed loop geothermal energy recovery energy efficient for widespread implementation.

This can be achieved by using a segregated power cycle with multilateral wellbores sealed without casing and sub-zero cooling and further with friction reducers added to the primary working fluid. In addition, as a further aspect, an integrated power cycle with multilateral wellbores sealed without casing can be employed where the working fluid is a mixture of polar and non-polar molecules which undergoes a phase change in the lateral portion of the well loop.

A further object of one embodiment of the present invention is to provide a method of generating power, comprising:
providing a sealed closed well loop circuit having an inlet and an outlet connected with at least one lateral conduit absent casing within a geological formation and a first working fluid;
providing a power generating circuit having a second working fluid, said circuit in thermal transfer communication with said well loop circuit;
circulating said first working fluid and said second working fluid within the respective circuits;
transferring heat from said first working fluid to said second working fluid; and
generating power from recovered heat energy.

A significant benefit of the technology discussed herein relates to the fact that thermodynamic efficiency is enhanced in subzero ° C. ambient conditions, as the second working fluid is cooled to subzero temperatures prior to engaging in heat transfer with the first working fluid. Traditional geothermal power systems typically use reservoir brine (water) as a working fluid and accordingly, absent the technology disclosed herein, could not be effectively employed in cooler ambient conditions. Reservoir brine typically has a freezing point similar to water and precipitates scale as temperature is lowered.

Modification of the first working fluid facilitates operation in lower subsurface temperatures and may be dynamically altered during operation to accommodate changing environmental conditions.

A further object of one embodiment of the present invention is to provide a method of generating power in a sealed well loop absent casing having an inlet well and an outlet well and at least one lateral conduit within a geological formation and power generating apparatus in operative communication with said well loop, comprising:
providing a working fluid containing a mixture of polar and non-polar molecules which undergo a phase-change in the lateral portion of the well loop;
providing a power generating circuit for utilizing recovered energy from said working fluid;
circulating said working fluid within said loop; and
generating power from recovered heat energy.

The absence of casing clearly has a significant impact on costs as an entire unit operation is eliminated from the implementation. Further, this allows the possibility for the wellbore to be lined during drilling obviating formation permeability issues. The lining may be conditioned with thermally conductive compounds to augment thermal conductivity for maximum energy transfer from the formation to the working fluid. For clarity, the lateral segments or conduits with not have casing, since these are effectively acting as thermal pathways for direct interaction with the working fluid. The inlet and outlet sections will include conventional arrangements for strength and integrity.

In the integrated system, a plurality of lateral segments or conduits sealed without the use of casing may be connected commonly to the inlet and outlet for enhanced thermal recovery. Individual throttling is achievable for the lateral segments or legs.

Such fluids disclosed herein have particular use in elevating the efficiency of an integrated closed-loop geothermal system at low depths (<1500 m), supra heretofore not recognized. It has been found that the recognition of fluid dynamics in combination with the advancements briefly discussed herein, render the methods and apparatus particularly effective in a wide temperature range, but also create effective use in a host of geological formations.

It has also been found that marked efficiencies are realizable by incorporating drag reducing agents in the working fluid(s) that do not degrade under high pressure, high temperature, or high shear rates. This reduces the parasitic pumping load of the system and enables higher net efficiency. The drag reducing agents may comprise surfactants. Suitable examples include Arquad® 12-50, Arquad® S-50, Arquad® R-50, Ethoquad® C/12, Ethoquad® O/12, Ethoquad® O/13, Ethoquad® R/12 or combinations. Other suitable congeners will apparent to one skilled in the art.

In respect of immediate advantages attributable to the technology herein, the following are apparent:
Significant increases in efficiencies of closed loop geothermal systems when coupled to known power cycles in a segregated configuration;
Operability in zero ° C. and subzero ° C. temperatures with increased efficiency;
Increase in net efficiency with the addition of a tailored shear-resistant drag reducing agent;
Maximized heat recovery in a geological formation using a plurality of lateral heat recovery conduits sealed without casing;
Independent throttling control of the well loops and plurality of lateral conduits;
Significant increases in efficiency of integrated closed-loop geothermal systems at shallower depths;
Working fluid composition dynamically adjustable to suit changing environmental conditions;
Retrofit capability for unused or suspended wells;
Repurpose of oil well drilling sites;
Expedited deployment relative to conventional systems, i.e. geothermal systems, solar, coal, nuclear, gas plants;
Distributed power which forgoes transmission losses;
Correlation of supply with demand for electric power (the closed well loop has a “negative beta” in that well-loop naturally produces more power on cold days when demand is up, thus helping balance supply and demand.);
Free exploration for lithium mining as well as oil and gas;
No produced fluids that need to be reinjected and/or cleaned up;
No scaling or maintenance issues associated with produced brine;
No risk of harming existing aquifers or adjacent oil producing formations;
Open-hole wellbores is the ideal manufacturing-style operation that is typical of resource plays with declining costs; and
Enables custom working fluids to be cooled to subzero temps, increasing “DeltaT”

Having thus generally described the invention, reference will now be made to the accompanying drawings.

### BRIEF DESCRIPTION OF THE DRAWINGS

FIG. 1 is a schematic illustration of a segregated well loop and power cycle in one embodiment;

FIG. 2 is a graphical illustration of net power output for a segregated closed-loop system used in conjunction with an organic Rankine cycle, with and without the subzero cooling;

FIG. 3 is a schematic illustration of a segregated well loop and power cycle with power circuits in parallel;

FIG. 4 is a schematic illustration of segregated well loop and power cycle with power circuits in series;

FIG. 5 is a schematic illustration of the multilateral conduit system;

FIG. 6 is a graphical representation of drag reduction percentage as a function of Reynolds number for a specific drag reducing agent;

FIG. 7 is a schematic illustration of a cross sectional view of the well loop and multilateral conduits in situ within a geological formation;

FIG. 8 is is a schematic illustration of an integrated well loop power cycle in one embodiment;

FIG. 9 is a schematic illustration of an integrated well loop power cycle in a second embodiment;

FIG. 10 is a graphical representation pressure-enthalpy conditions within an integrated power cycle corresponding to FIG. 8 of net power as a function of ambient temperature, for both prior art without subzero cooling and for a segregated system including subzero cooling; and

FIG. 11 is a graphical representation of the effectiveness of the ethane-ammonia mixture for power output compared to a segregated system using an organic Rankine cycle in identical conditions.

Similar numerals used in the Figures denote similar elements.

### DETAILED DESCRIPTION OF THE PREFERRED EMBODIMENTS

As a preface, reference to loop cycle, horizontal segments, multilaterals, horizontal segments, will be understood to mean that the closed loop includes at least one horizontally oriented section which is in contact with the surrounding formation from which heat is transferred. The inlet, outlet and remaining section form the completed loop. The loop circuit may include a plurality of horizontal wells.

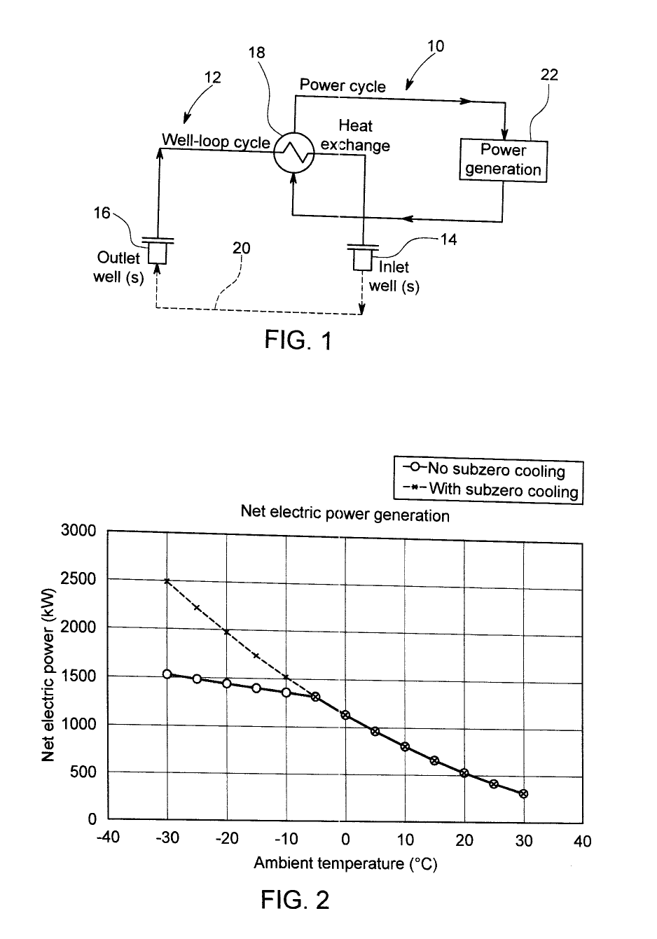

In FIG. 1, shown is a schematic illustration of first embodiment of the invention. This is referred to as a segregated well loop and power cycle. A power cycle 10 is integrated with a well loop cycle 12. The power cycle 10 may be selected from any of those suitable and known such as a Stirling cycle, carbon carrier cycle, Kalina cycle, organic Rankine cycle carbon dioxide transcritical power cycle, inter alia.

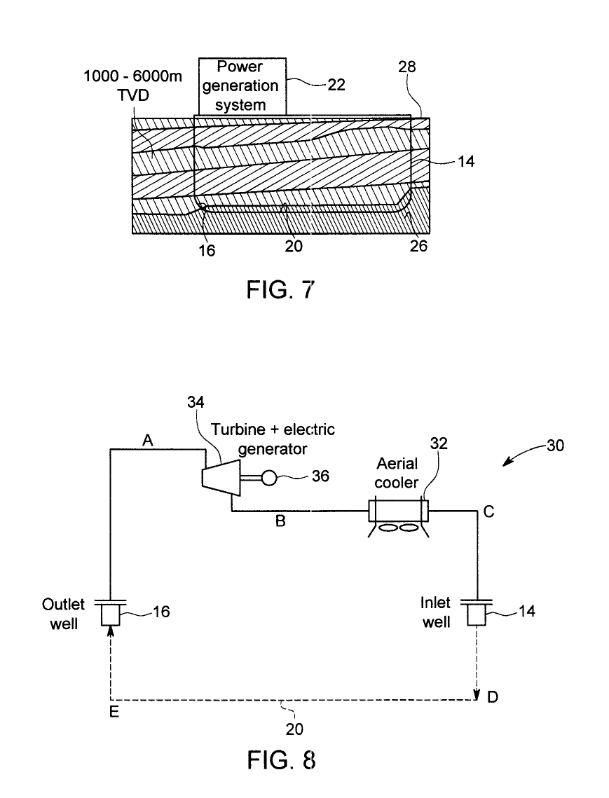

In the Figure, the well loop 12 comprises a closed loop system having an inlet well 14 and an outlet well 16, typically disposed within a geological formation, which may be, for example, a geothermal formation, low permeability formation, sedimentary formation, volcanic formation or “basement’ formation which is more appropriately described as crystalline rock occurring beneath the sedimentary basin (none being shown here—reference to FIG. 7 is illustrative). The inlet well 14 and outlet well 16 include the conventional structure necessary for integrity and strength, however the remainder of the circuit does not include any casing and this is equally applicable to advancing embodiments to be discussed herein after. The technology is directed to maximizing energy recovery and by eliminating the casing, a thermally ineffective interface is circumvented.

The well loop 12 and power cycle 10 are in thermal contact by heat exchanger 18 which recovers heat from the working fluid circulating in the loop circuit 20 in the formation which is subsequently used to generate power with generator (not shown) in power generation operation 22 in cycle 10. As an example, the temperature of the formation may be in the range of between 80° C. and 150° C. As an effective alternative, power generation operation 22, may be supplanted with a heat collection operation to allow for sale/distribution of heat for other uses/users.

In the arrangement illustrated, two distinct working fluids are used. By modifying the working fluid used within the well loop, operation of the system is possible at low temperatures.

The existing power cycles supra require a water-based fluid within the well loop itself which absorbs heat from the rock and then transfers this heat into the secondary power cycle working fluid in a heat exchanger. In conventional geothermal projects, the water chemistry is set by the reservoir conditions. In most cases the water is a heavy brine with high total dissolved solids (TDS) content above 10,000 ppm that causes two problems, namely corrosion and scaling. Corrosion issues in the downhole pipes, tools, and within the surface facility and surface flow lines are common and expensive to manage. In addition, there is usually significant silica or other precipitates in solution at the reservoir conditions. When the brine is brought to surface and cooled in the primary heat exchanger (to transfer energy into the power cycle's working fluid), silica or other minerals precipitate out of solution and adhere to the internal surfaces of pipes, valves, heat exchangers, etc. These scales are very expensive to manage and usually set a limit on how much heat can be extracted from the source water.

As such, currently available power generation modules usually limit the input temperature of the working fluid to above 0° C. in the primary heat exchanger. A higher turbine pressure ratio is enabled by dropping the working fluid temperature below zero. However, conventional geothermal projects are limited by potential freezing of the geothermal on the other side of the heat exchanger.

These limitations in present technology are traversed by implementing a binary working fluid system within a closed loop well. The working fluid in the power cycle may be modified with additives to prevent freezing at subzero ° C. temperatures. Suitable additives include supercritical carbon dioxide, anti-scaling agents, anti-corrosion agents, friction reducers, and anti-freezing chemicals, refrigerants, hydrocarbons, alcohols, organic fluids and combinations thereof.

A substantial benefit of the binary working fluid in combination with the well loop is that it is unaffected by very cold ambient temperatures and thus facilitates use of any generic power cycle (including ORC, Kalina, carbon carrier cycle) to be used to increase higher net power production when used in conjunction with a well loop as set forth in FIG. 1. In this arrangement heat is transferred from the first working fluid to the second working fluid when the temperature of the second working fluid is at zero ° C. or subzero ° C. FIG. 2 depicts net power output for a segregated closed-loop system used in conjunction with an Organic Rankine Cycle, with and without the subzero cooling technology disclosed herein.

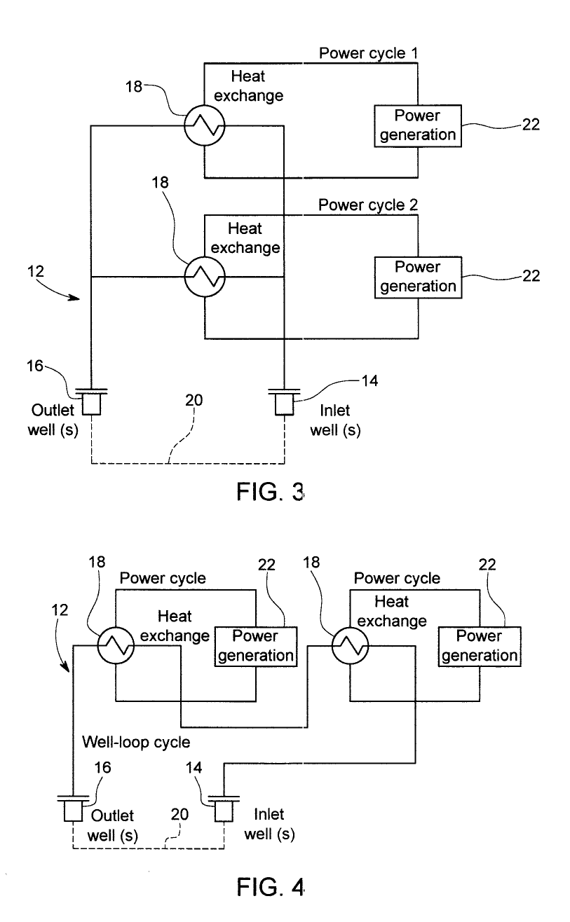

Optional arrangements with the segregated circuit are illustrated in FIGS. 3, 4 and 5.

FIG. 3 illustrates a segregated circuit incorporating a well loop 12 in thermal contact with two distinct heat exchangers 18 each with its own power generator (not shown) in power generation operation 22 forming a parallel arrangement. Similarly, FIG. 4, illustrates a serial arrangement.

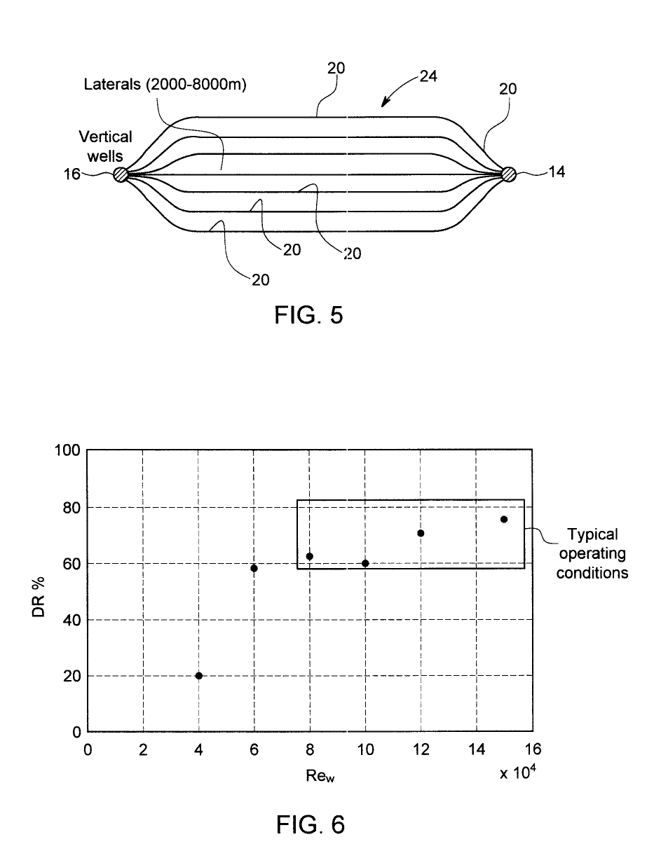

Turning to FIG. 5, schematically illustrated is partially cut away view of a multilateral well loop system, globally denoted by numeral 24. in this arrangement a plurality of horizontal well loop segments 20 are disposed within the formation (not shown) in spaced apart radial relation. Each of the lateral or horizontal segments 20 is commonly connected to the vertically disposed inlet well 14 and the vertically disposed outlet well 16 in a closed loop. As noted supra the segments 20 are devoid of any casing.

FIG. 6 illustrates a graphical representation of drag reduction as a function of Reynolds number for C18TAC, octadecyl trimethyl ammonium chloride. For typical loop shear rate conditions set forth herein, a 60%-80% reduction in drag is noted. For purposes of perspective, a 70% drag reduction, results in approximately a 25% higher net power generation for a typical closed loop installation as set forth herein with a 125° C. formation temperature and 12 5000 m multilateral wells. This represents a significant advancement and is demonstrative of the effectiveness of the instant technology.

In the prior art, geothermal systems could not take advantage of the agents, since they are open systems which would require continuous purchase and injection of the agents, which is cost prohibitive. Further more, for closed systems, these recirculate fluid continuously at high shear rates, especially within the primary heat exchanger, requiring suitable drag reducing agents that do not degrade under such conditions.

FIG. 7 schematically illustrates the disposition of the elements within a geological formation 26. The formation may be, for example, a geothermal formation, low permeability formation, sedimentary formation, volcanic formation or “basement” formation which is more appropriately described as crystalline rock occurring beneath the sedimentary basin. In terms of an apparatus example, the horizontal segments 20 may be anywhere from 2000 metres to 8000 metres or more in length and from 1000 metres to 8000 metres in depth from the surface 28. Power generation 22 operation on surface 28 is disposed between the inlet well 14 and the outlet well 16 to complete the closed loop system.

It will appreciated by those skilled in the art that the dimensions are exemplary only and will vary depending on the properties of the formation, area, surface anomalies, tectonics, etc.

As will be evident, owing to advances in engineering, intrusiveness for establishing the multilateral arrangement is minimal and simplified to provide a substantial increase in surface area for the loops to contact the formation. Further, retrofit applications are possible for unused or suspended oil wells to repurpose same with negligible environmental impact. Referring back to FIG. 7, the arrangement depicted has apparatus commonality with an oil well system. Accordingly, the instant technology can be combined with unused, suspended or otherwise inoperative well sites to create an energy recovery opportunity.

Having discussed the segregated circuit, reference to FIGS. 8 et. seq. will now disseminate the integrated well loop system.

The integrated well loop power cycle is a closed loop system in which the selected working fluid is circulated within the well loop and then flows into a turbine on surface as shown in FIG. 8. Numeral 30 denotes the overall process schematic. In this process, a single-fluid is used rather than having a discrete well loop fluid and a secondary power cycle working fluid. The working fluid in this closed loop cycle can operate either as a Rankine cycle, whereby the fluid undergoes a phase change at both upper and lower pressures; a transcritical cycle, whereby the fluid is supercritical at the upper working pressure and subcritical at the lower working pressure; or as an entirely supercritical cycle whereby the fluid remains supercritical at the lower working pressure. CO2 is an example of a transcritical or supercritical cycle discussed in prior art.

As is known, a Rankine cycle is a thermodynamic cycle where the working fluid goes through a phase change at both the upper and lower pressure of the cycle. An ethane-ammonia mixture is an ideal example of a mixture of polar and non-polar molecules employed in an integrated well-loop circuit. Due to the immiscibility of these molecules at high pressures it is possible to design a system which enables a phase change even at low geothermal temperatures (<150° C.) and high subsurface pressure. Thus, ethane-ammonia mixture enables an integrated well-loop Rankine cycle, which in many conditions has higher efficiency than prior art.

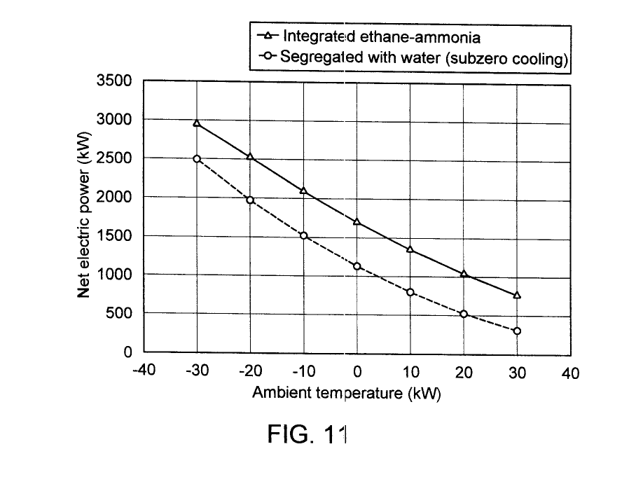

The apparatus further includes a cooling device, shown in the example as an aerial cooler 32 and turbine 34 with generator 36. The aerial cooler is used to cool the working fluid to a temperature between 1° C. and 15° C. above ambient temperature. It is also to be noted that the working fluid can be cooled to a subzero° C. temperature. Reference to FIGS. 10 and 11, herein after delineates performance data compared to the prior art (well-loop working fluid is water and segregated power system is an Organic Rankine Cycle on surface).

The driving mechanism in this integrated cycle is a very strong thermosiphon which arises due to the density difference between the inlet vertical well 14 and the outlet vertical well 16. The fluid is in a liquid state in the inlet well 14, heats up as it travels along the lateral section 20, exits in a predominately gas state in the outlet well 16, which creates significant pressure.

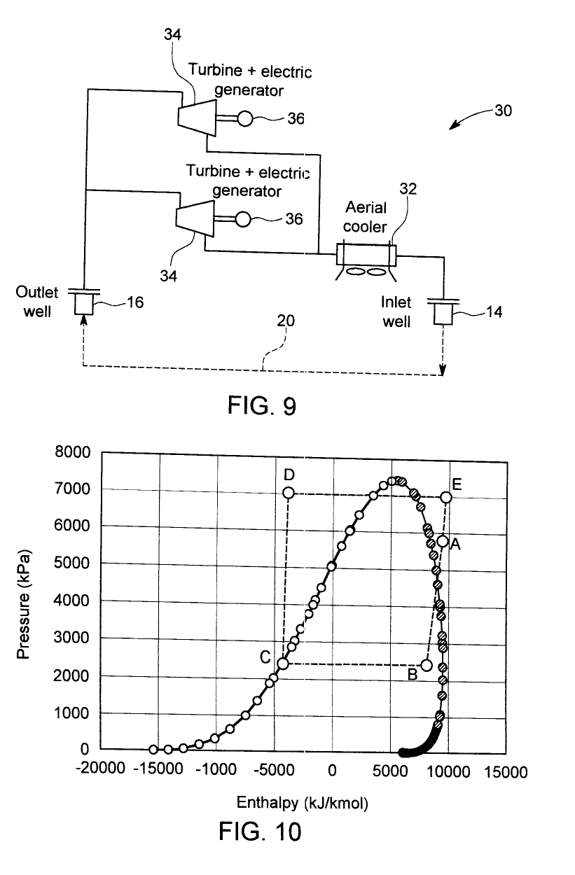

FIG. 9 is a variation of the flow diagram illustrated in FIG. 8, where a plurality of turbines 34 and generators 36 are disposed in a parallel relationship. Other variations including combinations of series and parallel will be appreciated by those skilled in the art.

FIG. 10 illustrates a graph of pressure as a function of enthalpy for the fluid at different positions A through E, reference to which can be found on FIG. 8. For clarity, position A represents the turbine in position, position B represents the turbine out position, position C represents the aerial cooler out position, position D represents the lateral section in position and position E represents the lateral section out position.

FIG. 11 depicts the effectiveness of the closed loop system discussed herein in respect of power generation. By taking advantage of the closed loop, the instant technology is not susceptible to the prior art geothermal systems. In the prior art, subzero cooling could not be exploited, since known systems produce brine. Under subzero conditions, the brine freezes or otherwise precipitates mineral scale, both of which plug heat exchanger tubes and other equipment.

Working in concert with the integrated well loop circuit is the use of customized fluids and mixtures tailored to the wellbore layout, depth, length, and ambient temperature. The prior art only discusses the use of carbon dioxide or pure hydrocarbon fluids. With a closed-loop system such as that discussed herein, the initial cost and complexity of a fluid mixtures is only a minor factor in the overall economics. So other fluids such as refrigerants, hydrocarbons, alcohols or organic fluids, or any combinations thereof are useful.

In the Figure, the effectiveness of specific fluids and mixtures is illustrated. It is evident that there is a pronounced effect on power gain using the ethane-ammonia mixture, which is an example of a mixture of polar and non-polar molecules.

To use a single turbine and have adequate efficiency over an entire range of ambient conditions is problematic. It has been found that use of two or more turbines in series or parallel which are optimized for different ambient conditions addresses the problem. During periods of colder temperatures, control logic (not shown) automatically shifts the working fluid to the appropriate turbine to maintain high efficiency throughout the year.

In conclusion, new technology has been presented for generating power in a unique closed loop arrangement within a variety of geological formations.

Segregated loops with a binary working fluid system with improved fluids has been delineated resulting in enhanced efficiency in prior art power cycles. Integrated cycles have been shown using a single working fluid and presenting thermosiphon drive to substantially reduce or eliminate parasitic load to enhance efficiency.

Multilateral segments in the loop commonly connected to the inlet and outlet of the loop have been discussed in many terms not the least of which is the improvement to existing loop arrangements.

Finally, the integration or retrofitting of unused or suspended wells with the instant technology has been promulgated.

We claim:

1. A method of generating power, comprising:
providing a sealed closed well loop circuit having an inlet and an outlet connected with at least one lateral conduit within a geological formation and a first working fluid, said lateral conduit absent casing;
providing a power generating circuit having a second working fluid, said circuit in thermal transfer communication with said well loop circuit;
circulating said first working fluid and said second working fluid within the respective circuits;
transferring heat from said first working fluid to said second working fluid; and
generating power from recovered heat energy.

2. The method as set forth in claim 1, wherein heat is transferred from said first working fluid to said second working fluid when the temperature of said second working fluid is at zero ° C. or subzero ° C.

3. The method as set forth in claim 1, further including the step of introducing a drag reducing additive into said first working fluid.

4. The method as set forth in claim 3, wherein said drag reducing additive contains a surfactant, a polymeric compound, and combinations thereof.

5. The method as set forth in claim 4, further including introducing a stabilizing agent to reduce intramolecular degrading interaction within said additive.

6. The method as set forth in claim 1, further including introducing anti-scaling agents, anti-corrosion agents, and anti-freezing chemicals, hydrocarbons, alcohols, organic fluids and combinations thereof into said first working fluid.

7. The method as set forth in claim 1, wherein said geological formation comprises a formation selected from the group comprising: a geothermal formation, a low permeability formation, a sedimentary formation and a volcanic formation

8. The method as set forth in claim 1, wherein said formation is crystalline rock occurring beneath the sedimentary basin.

9. The method as set forth in claim 1, wherein power is generated using a generating circuit operating on a cycle selected from the group comprising: Organic Rankine cycle, a Kalina cycle, a carbon carrier cycle and a Stirling cycle.

10. The method as set forth in claim 1, further including the step of separately controlling the flow of said first working fluid in each lateral conduit where a plurality are present.

11. A method of generating power in a sealed closed well loop having an inlet well and an outlet well and at least one lateral conduit absent casing within a geological formation and power generating apparatus in operative communication with said well loop, comprising:
providing a working fluid containing a mixture of polar and non-polar molecules which undergo a phase-change in the lateral portion of the well-loop;
providing a power generating circuit for utilizing recovered energy from said working fluid;
circulating said working fluid within said loop; and
generating power from recovered heat energy.

12. The method as set forth in claim 11, wherein said working fluid comprises ethane.

13. The method as set forth in claim 11, wherein said working fluid comprises ammonia.

14. The method as set forth in claim 11, wherein said working fluid comprises ammonia-ethane mixture.

15. The method as set forth in claim 11, further including introducing anti-scaling agents, anti-corrosion agents, friction reducers, and combinations thereof into said working fluid.

16. The method as set forth in claim 11, further including the step of cooling said working fluid prior to recirculation in said loop at said inlet.

17. The method as set forth in claim 11, wherein said working fluid is cooled to a temperature between 1° C. and 15° C. above ambient temperature prior to recirculation in said loop at said inlet.

18. The method as set forth in claim 11, wherein said working fluid is cooled to a subzero° C. temperature prior to recirculation in said loop at said inlet.

19. The method as set forth in claim 11, wherein circulation is effected by thermosiphon action.

20. A method of recovering heat in a sealed closed well loop having an inlet well and an outlet well and at least one lateral conduit absent casing within a geological formation and heat transfer apparatus in operative communication with said well loop, comprising:
providing a working fluid circulating within said loop;
and recovering heat energy for subsequent use.
